(19) United States
(12) Patent Application Publication
(10) Pub. No.: US 2020/0300459 A1
(43) Pub. Date: Sep. 24, 2020

(54) BURNER ASSEMBLY

(71) Applicant: Linde Aktiengesellschaft, München (DE)

(72) Inventors: Ronald STEUSLOFF, Neukloster (DE); Heinz-Dieter ESSER, Hürtgenwald (DE); Daniel RUH, Kreuzlingen (DE)

(21) Appl. No.: 16/823,390

(22) Filed: Mar. 19, 2020

(30) Foreign Application Priority Data
Mar. 19, 2019 (EP) 19020134.3

(51) Int. Cl. F23D 14/02; F23K 5/00; F23D 14/48; F23L 7/00; B23K 31/02; F16L 9/06

(52) U.S. Cl. CPC F23D 14/02; F23K 5/007; F23D 14/48; B23K 2101/04; B23K 31/02; F16L 9/06; F23D 2900/14641; F23L 7/007

(57) ABSTRACT

The invention relates to a burner assembly (100) comprising at least two gas supply lines (1, 2) for supplying at least two different gases, a gas mixture supply line assembly (11), in which the mixture of the at least two different gases is passed on and fed to at least one burner head (20) in which the mixture is combusted, wherein the gas mixture supply line assembly (11) and/or at least one of the gas supply lines has at least one flexible metal tube (1, 2, 13, 16, 19, 21).

### CROSS-REFERENCE TO RELATED APPLICATIONS

This application claims the benefit of European Patent Application No. EP 19020134.3 filed Mar. 19, 2019, the disclosure of which is herein incorporated by reference in its entirety.

The invention relates to a burner assembly comprising at least two gas supply lines for supplying at least two different gases, a mixing area in which the at least two different gases are mixed with one another, a gas mixture supply line assembly in which the mixture of the at least two different gases is passed on and fed to at least one burner head in which the mixture is combusted.

### PRIOR ART

Preheating of workpieces is required in a wide variety of material machining and manufacturing processes. In known welding methods, the workpieces to be welded are preheated for different reasons. The main danger with insufficient preheating is so-called “hydrogen embrittlement” in the heat-affected zone. At elevated cooling rates, such as those that occur without preheating, convertible steels also tend to harden there. This results in an increased tendency to cold-cracking in the joining region of the workpiece. These disadvantages also increase, for example, in the welding of tubes with increasing tube diameter. The hardness achievable thereby and thus the risk of cold-cracking essentially depends on the thickness of the workpiece to be machined, on the two- or three-dimensional heat dissipation, on existing alloy elements and their contents, on the heat input of the welding method in question and/or on the component temperature. The last can be influenced by the preheating. The preheating reduces the cooling rate of the seam region and improves hydrogen effusion. As a rule, it has a favorable effect on the residual intrinsic stress state of the welded connection. The preheating temperature required can be determined in each case and the heat to be introduced and/or the use of the preheating device in question can be determined as a function thereof. In particular, the basic toughness of the material, its wall thickness, the seam shape, the welding technique employed and the welding speed must be taken into account when determining the preheating temperature. In principle, preheating is required at processing temperatures of less than 5° C. and when certain limit thicknesses are exceeded (above all in the case of high-strength steels). The preheating temperature is, for example, 80 to 200° C.

For preheating workpieces prior to welding, it is generally preferred to use multi-flame burners, which are operated, for example, with fuel mixtures containing acetylene and oxygen or with acetylene and compressed air, for the reasons described in more detail below. Preheating takes place in order to prepare an area near the seam on the workpiece (for example, a tube or conduit) for the subsequent application of a seam in this preheated area, which is therefore already warm at the beginning of the welding process (here “warm” means at least warmer than the ambient air).

EP 2724806 A1, for example, discloses a multi-flame burner assembly suitable for preheating a workpiece. In a preferred embodiment, this has a feed line, which can also be referred to as a shaft or, in other words, also as a pipe and is suitably manufactured from a metallic material in order to supply the fuel. By means of a bent design, it acquires an adaptability, highly advantageous for the present invention, to the shape of the workpiece to be preheated, i.e., for example, to the rounding of a conduit to be preheated. Stainless steel is particularly suitable as a metallic material for such a bent design. The feed line simultaneously serves as a fuel distributor and fastening device for burner heads. A corresponding feed line can be curved, for example, and can thereby be adapted to the shape of a workpiece to be heated. In the production of a multi-flame burner, the feed line is advantageously deformed in such a way that it essentially reproduces the corresponding shape of the workpiece. This means that, for example, a circular segment is provided which has the same center point as a (large-diameter) tube to be preheated and a bend adapted in accordance with the larger radius (radius of tube plus radial distance between tube and feed line). In addition, other shapes may also be advantageous.

However, it is disadvantageous for such metallic fuel feeds, once manufactured, to be fixed in their shape. Different burner assemblies therefore need to be produced for different workpiece geometries.

The application is not restricted only to burners for preheating.

The object of the invention is accordingly to alleviate or entirely overcome the above-mentioned problems.

### SUMMARY OF THE INVENTION

The invention proposes a burner assembly in accordance with the independent patent claim. Advantageous embodiments result from the dependent claims and the following description.

### Advantages of the Invention

According to the invention, a burner assembly comprises at least two gas supply lines for supplying at least two different gases, a mixing section or a mixing area in which the at least two different gases are mixed with one another, a gas mixture supply line assembly in which the mixture of the at least two different gases is passed on and fed to at least one burner head in which the mixture is combusted, wherein the gas mixture supply line assembly and/or at least one of the gas supply lines has at least one flexible metal hose.

A flexible metal hose is a flexible element that allows an adaptability of the burner assembly to a workpiece even after production of the burner assembly. Such a burner assembly is clearly advantageous over the prior art, particularly in the case of preheating tubes of different diameters. Accuracy in positioning is improved. Simpler handling is made possible for the user. A single burner assembly adapts to different workpiece geometries, this being accompanied by a cost reduction. Freer and more specific burner shapes are also possible due to the at least one flexible metal tube. Compared to rubber hoses, mechanical stability, temperature resistance and service life are increased. Flexible metal hoses allow the user to position the valves and other control devices or a machine shaft with adjustment valves of the burner assembly during use such that they are not damaged by the burner flames and that they are in an area that is optimally accessible for the operator.

The gas mixture supply line assembly consists of all the elements arranged between the mixing section (including the same) and the burner head or heads. A gas mixture supply line assembly is thus to be understood in particular as an area between the mixing section and the burner or a corresponding distributor pipe of the burner.

In particular, at least one of the at least two gas supply lines is connected to an oxygen supply and/or a compressed air supply and/or at least one of the at least two gas supply lines is connected to a fuel gas supply, for example to an acetylene supply. In this way, it is preferably possible to produce a fuel-gas/compressed-air mixture and/or a fuel-gas/oxygen mixture, for example an acetylene and compressed-air mixture and/or an acetylene and oxygen mixture, in the mixing device, which has highly reliable combustion properties at high flame temperatures.

In a preferred embodiment, the at least one flexible metal tube takes the form of a corrugated metal hose. Corrugated metal hoses are particularly robust flexible metal hoses.

It is conceivable for the at least one flexible metal hose to be fastened by means of screw connections. A reversible assembly can be achieved in this way. However, screw connections are not restrictive. Other gas-tight connections are also possible, for example welding or flange connections.

The mixture supply line assembly preferably has a distributor line assembly on which at least two combustion heads are arranged. Such a distributor line assembly can comprise a suitable number of combustion heads, for example three to nine or even more burner heads. In this way, a reduced heat output can be achieved in a smaller space.

In particular, the distributor line assembly has at least two, preferably three to eight distributor sections, which are all mutually connected by a flexible metal hose. In this way, the different distribution sections can be adjusted in their angle to each other and adapted to a workpiece geometry.

It is also conceivable for at least one of the combustion heads to be connected to the distributor line assembly by a flexible metal hose. In this way, the angle can also be adjusted here.

In an advantageous embodiment, the gas mixture supply line assembly has at least one flexible metal hose upstream of the distributor line assembly. In this way, the distributor line assembly can be adapted in its angle to valves and control units.

The burner assembly preferably has at least one teardrop nozzle burner. Such a teardrop nozzle burner is a particularly efficient burner concept, which can advantageously be connected by flexible metal hoses to a burner assembly. Alternatively or additionally, the burner assembly preferably has at least one block burner.

Further advantages and embodiments of the invention arise from the description and the accompanying drawing.

It is to be understood that the features mentioned above and below may be used not only in the particular combination specified, but also in other combinations or by themselves, without departing from the scope of the present invention.

The invention is schematically illustrated in the drawings with reference to exemplary embodiments and will be described below with reference to the drawings.

### BRIEF DESCRIPTION OF THE DRAWINGS

FIG. 1 shows a preferred embodiment of a burner assembly according to the invention in a schematic representation;

FIG. 2 shows another preferred embodiment of a burner assembly according to the invention in a schematic representation;

FIG. 3 shows another preferred embodiment of a burner assembly according to the invention in a schematic representation;

FIG. 4 shows a combustion head for connection to an embodiment of a burner assembly according to the invention;

FIG. 5 shows another preferred embodiment of a burner assembly according to the invention in a schematic representation.

### DETAILED DESCRIPTION OF DRAWINGS

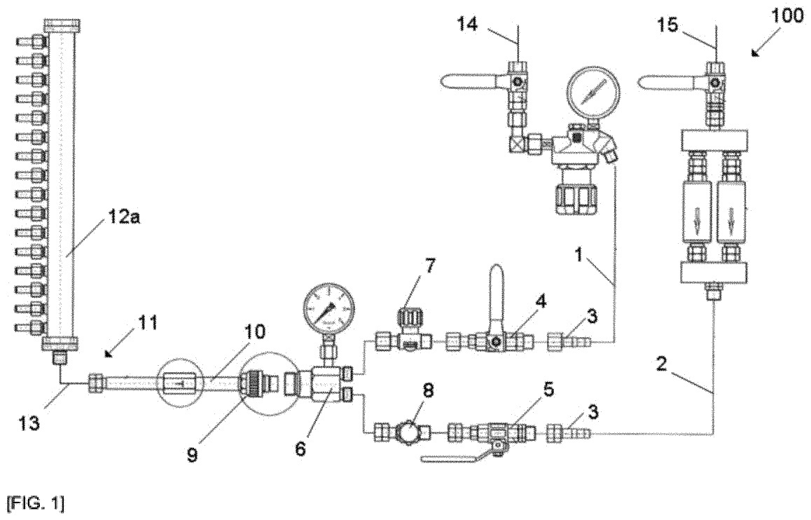

In FIG. 1, a preferred embodiment of a burner assembly according to the invention is schematically illustrated and denoted by 100.

The burner assembly 100 has two gas supply lines for feeding two different gases. A compressed air supply and a fuel gas supply line, for example an acetylene feed, can each comprise, for example, a pipe 14, 15 or, for example, also a flexible metal hose.

Furthermore, the compressed air supply has a compressed air hose 1 downstream of the pipe 14. This can be realized as a flexible metal hose or as a rubber hose. The fuel gas supply line has a fuel gas hose 2, which is arranged downstream of the pipe 15. This can likewise be realized either as a flexible metal hose or as a rubber hose.

The compressed air hose 1 is connected at its other end to a hose sleeve with a union nut 3. This hose sleeve 3 is in turn connected to a quick-release valve 4. This allows the compressed air supply to be opened and closed easily. An adjusting valve 7, which enables pressure regulation, is arranged downstream of the quick-release valve 4.

The fuel gas hose 2 can also be connected at its further end to a hose sleeve with a union nut 3, which in turn is connected to a quick-release valve 5. An adjusting valve 8 is arranged downstream thereof.

The compressed air supply and the fuel gas supply line are brought together in a machine shaft 6, which is connected to a mixing section 10 via a union nut 9.

The burner assembly 100 further includes a gas mixture supply line assembly 11 having a flexible metal hose 13 for connection to a teardrop nozzle burner 12a. Teardrop nozzle burners are characterized by a high exit velocity, as a result of which lanceolate flame shapes can be achieved. In this simple embodiment, the gas mixture supply line assembly 11 consists only of the flexible metal hose 13. However, the gas mixture supply line assembly 11 is not restricted thereto. It may further comprise, for example, a tube or a plurality of tubes and a distributor line assembly for passing on to one or more burner heads and/or burners. Alternatively, it is also conceivable for the mixing section to be directly connectable to the teardrop nozzle burner 12a.

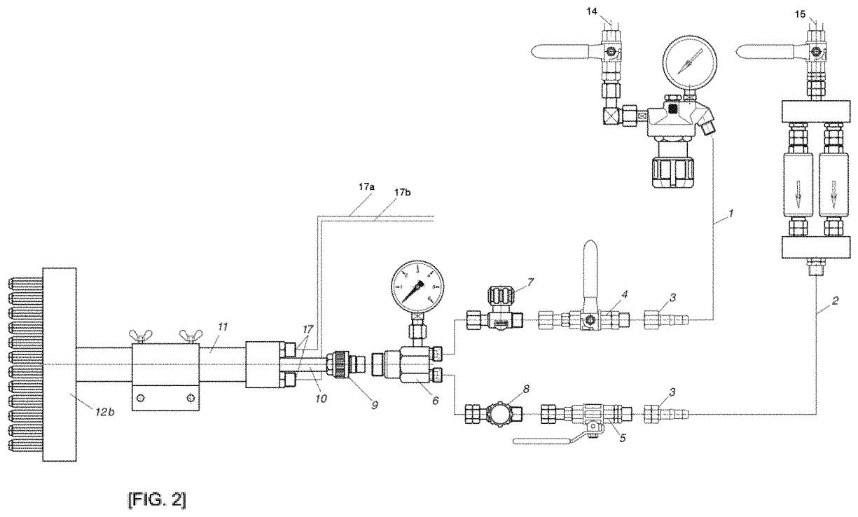

FIG. 2 shows another embodiment of a burner assembly 100 according to the invention. The same reference symbols denote the same elements as in FIG. 1 and will not be described again here. The difference from FIG. 1 is that here, instead of a teardrop nozzle burner 12a, a block burner 12b is provided.

Furthermore, a water-cooling device 17 having a supply line 17a and a return line 17b is provided between mixing section 10 and gas mixture supply line assembly 11.

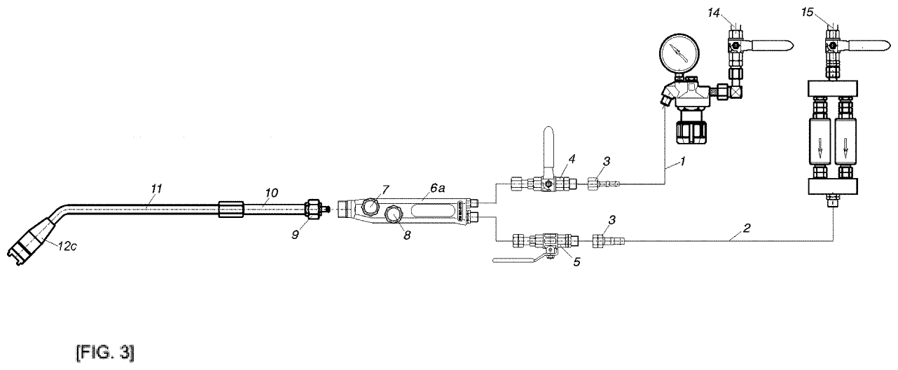

FIG. 3 schematically illustrates another embodiment of a burner assembly 100 according to the invention. The same reference symbols denote the same elements as in FIGS. 1 and 2 and will not be described again. The burner assembly 100 shown in FIG. 3 takes the form of an oxygen or compressed-air burner 12c with a handpiece. Instead of the machine shaft 6, the burner assembly 100 has a handle 6a on which the adjusting valves 7 and 8 are arranged.

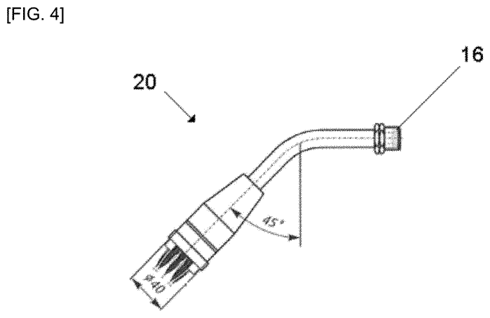

FIG. 4 shows an exemplary burner head 20 for connection to an embodiment of a burner assembly according to the invention. The burner head can have, for example, an offset at an angle of 45° here, wherein a flexible metal tube 16 can be provided as the connecting means. Here, the burner head has a diameter of 40 mm.

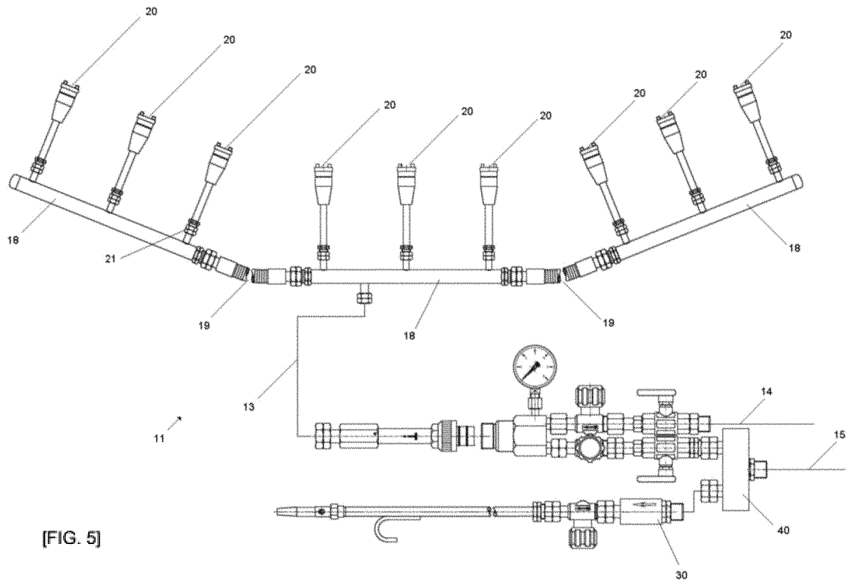

FIG. 5 shows another embodiment of a burner assembly 100 according to the invention. This has a fuel gas supply line 15 with a Y-piece 40, to which an ignition burner 30 is additionally connected. This is advantageously suitable for igniting the actual burner assembly. A compressed air supply is designated by 14.

In this embodiment, a mixture supply line assembly 11 includes a distributor line assembly. This distributor line assembly comprises three distributor sections 18 connected together by flexible metal hoses 19. The distributor sections 18 take the form of tubes, on each of which three burner heads 20 are arranged. The burner heads 20 may optionally be coupled to the distributor sections 18 in each case by a flexible metal tube 21. Even the line 13 between the mixing area and the distributor line assembly can be manufactured entirely or partially from a flexible metal tube.

Fuel gas such as acetylene is usually supplied at a pressure of up to 1.5 bar.

Compressed air is supplied at a pressure of up to 7.0 bar.

The flexible metal tubes can advantageously have diameters between 10 mm and 100 mm.

1. Burner assembly (100) having at least two gas supply lines (1, 2, 14, 15) for supplying at least two different gases, a mixing section (10) in which the at least two different gases are mixed with one another, a gas mixture supply line assembly (11) in which the mixture of the at least two different gases is passed on and fed to at least one burner head (20) in which the mixture is combusted,
characterized in that
the gas mixture supply line assembly (11) and/or at least one of the gas supply lines (1, 2) comprise at least one flexible metal hose (1, 2, 13, 16, 19, 21).

2. The burner assembly (100) according to claim 1, wherein at least one of the at least two gas supply lines (14, 15) is connected to an oxygen supply and/or a compressed air supply.

3. The burner assembly (100) according to claim 1, wherein at least one of the at least two gas supply lines (14, 15) is connected to a fuel gas supply.

4. The burner assembly (100), wherein the at least one flexible metal hose (1, 2, 13, 16, 19, 21) takes the form of a corrugated metal hose.

5. The burner assembly (100) according to claim 1, wherein the at least one flexible metal hose (1, 2, 13, 16, 19, 21) is fastened by means of screw connections.

6. The burner assembly (100) according to claim 1, wherein the mixture feed assembly (11) comprises a distributor line assembly on which at least two combustion heads (20) are arranged.

7. The burner assembly (100) according to claim 6, wherein the distributor line assembly comprises at least two distributor sections (18), each interconnected by a flexible metal hose (19).

8. The burner assembly (100) according to claim 6, wherein at least one of the combustion heads (20) is connected to the distributor line assembly by a flexible metal hose (21).

9. The burner assembly (100) according to claim 6, wherein the gas mixture supply line assembly (11) has at least one flexible metal tube upstream of the distributor line assembly.

10. The burner assembly (100) according to claim 1, comprising at least one teardrop nozzle burner (12a).

11. The burner assembly (100) according to claim 1, comprising at least one block burner (12b).
